(19) United States
(12) Patent Application Publication
(10) Pub. No.: US 2003/0162518 A1
(43) Pub. Date: Aug. 28, 2003

(54) Rapid acquisition and tracking system for a wireless packet-based communication device

(76) Inventors: Keith R. Baldwin, Melbourne Beach, FL (US); Mark A. Webster, Indian Harbour Beach, FL (US); Donald K. Whitney, West Melbourne, FL (US); Donald S. Langford, Melbourne Beach, FL (US); James R. Paviol, Melbourne, FL (US)

Correspondence Address: Gary R. Stanford, Law Offices of Gary R. Stanford, 610 West Lynn, Austin, TX, 78703, US

(21) Appl. No.: 10/172,463

(22) Filed: Jun. 14, 2002

Related U.S. Application Data
(60) Provisional application No. 60/359,212, filed on Feb. 22, 2002.

(51) Int. Cl. H04B 1/06

(52) U.S. Cl. 455/253.2; 455/251.1; 455/234.1

(57) ABSTRACT

A rapid acquisition gain control system for use in a wireless communication device having an RF input and a receive signal path including RF and baseband portions. The system includes two or more dual-state gain elements, two or more power detectors and control logic. The gain elements are sequentially coupled in the receive signal path of the wireless device and collectively have multiple combined gain states. Each combined gain state corresponds to one of several gain range segments of a predetermined dynamic range. Each power detector is coupled to detect an output power level associated with one of the gain elements. The control logic changes the combined gain state of the gain elements if a change of power level of energy processed in the receive signal path exceeds a predetermined threshold and a different combined gain state is indicated by the power detectors.

### CROSS-REFERENCE TO RELATED APPLICATION(S)

The present application is based on U.S. Provisional Patent Application entitled “Rapid Acquisition And Tracking System For A Wireless Packet-Based Communication Device”, Serial No. 60/359,212, filed Feb. 22, 2002, which is hereby incorporated by reference in its entirety.

### FIELD OF THE INVENTION

The present invention relates to wireless communications, and more particularly to a rapid acquisition and tracking system for a wireless communications device using one or more multiple gain state amplifiers followed by a continuously variable amplifier with signal measurement and processing functions controlled by a centralized state machine.

### DESCRIPTION OF RELATED ART

Wireless packet-based communication, such as that used for wireless local area networks (WLANs) and the like, is becoming increasingly complex. Newer standards, such as Institute of Electrical and Electronics Engineers, Inc. (IEEE) 802.11a standard, among other standards or wireless communication architectures, employ higher frequency operation using more sophisticated modulation schemes to increase data throughput. The signals based on the more sophisticated techniques, however, are also less robust in the face of interference including multipath interference and effects, thereby reducing the effective range of the transmitter for a given transmission power level. The wireless receiver is tasked with the requirement to detect and accurately acquire incoming signals as soon as possible within acceptable packet error rate (PER) limits. In this manner, the wireless transceiver must have a relatively large dynamic range to detect both weak and strong signals and must determine the appropriate gain range of valid packets transmitted in the wireless medium as quickly as possible.

In typical power detection schemes, a logarithmic amplifier (“log amp”) was used to estimate the power at a single point in the receive chain. The single log amp was required to have a relatively large dynamic range and accuracy specifications that were difficult to achieve. The Institute of Electrical and Electronics Engineers, Inc. (IEEE) 802.11a standard employs a short preamble requiring an increase in the speed of power level determination. In the log amp approach, additional higher resolution analog to digital (ADC) conversion would be required, resulting in additional delay that is counterproductive and that must be overcome to meet the increased speed requirement. In other known power detection approaches, the gain and variation of the signal in the receive chain had to be estimated and accounted for with indirect methods that often lead to inaccurate power level readings.

### SUMMARY OF THE INVENTION

A rapid acquisition gain control system according to embodiments of the present invention is disclosed for use in a wireless communication device having a radio frequency (RF) input and a receive signal path including RF and baseband portions. The system includes two or more multi-state gain elements, two or more power detectors and control logic. The multi-state gain elements are sequentially coupled in the receive signal path of the wireless device and collectively have multiple combined gain states. Each combined gain state corresponds to one of several gain range segments of a predetermined dynamic range. Each power detector is coupled to detect an output power level associated with one of the multi-state gain elements. The control logic changes the combined gain state of the multi-state gain elements if a change of power level of energy processed in the receive signal path exceeds a predetermined threshold and a different combined gain state is indicated by the power detectors.

In various embodiments, the multi-state gain elements may be dual-state gain elements. The gain elements may be located anywhere in the received path. In one configuration, the gain elements are distributed in frequency between RF and baseband. In one distributed embodiment in which the receive signal path includes an intermediate frequency (IF) portion, a first gain element is located at RF, a second gain element is located at IF and a third gain element is located at baseband.

In a more particular embodiment with first, second and third dual-state gain elements, the combined gain states are simplified to include only four allowable states. The four states include a first combined gain state in which the first, second and third gain elements are at high gain states, a second combined gain state in which the first and second gain elements are at high gain states and the third gain element is at a low gain state, a third combined gain state in which the first gain element is at a high gain state and the second and third gain elements are at low gain states, and a fourth combined gain state in which the first, second and third gain elements are at low gain states.

The power detectors may include a first power detector that indicates power overload of the first gain element, a second power detector that indicates power overload of the second gain element, and a third power detector that indicates power overload of the third gain element. The control logic enters an unlock state upon detecting a change of power that exceeds the predetermined threshold. If the power level increases, the control logic maintains an existing combined gain state if none of the first, second and third power detectors indicate power overload, changes to the fourth combined gain state if the first power detector indicates power overload, changes to the third combined gain state if the first power detector does not indicate power overload and the second power detector indicates power overload, and changes to the second combined gain state if the first and second power detectors do not indicate power overload and the first power detector indicates power overload. Upon entering the unlock state due to power level decrease, the control logic changes to the first combined gain state. The control logic may incorporate a delay state after an initial combined gain state change and may perform at least one subsequent combined gain state change in the event any of the power detectors indicate power overload prior to settling of input power level.

The predetermined threshold may include a first predetermined threshold used when the energy processed in the receive signal path comprises noise and a second, higher power level predetermined threshold when the energy processed in the receive signal path comprises a packet. The rapid acquisition gain control system may further include packet processing logic that monitors baseband signals to identify packets and that asserts a packet signal indicative thereof (which may be used, for example, to distinguish between noise and packets). Furthermore, the control logic may track baseband power level and include a state machine that operates in locked and unlocked states. For example, the state machine operates in a locked state while tracking the energy processed in the receive signal path and switches to an unlocked state if the first predetermined threshold is exceeded while noise is indicated and switches to the unlocked state if the second predetermined threshold is exceeded while a packet is indicated. In this manner, different thresholds are used for noise and packets. The first predetermined threshold may include a power change window that includes positive and negative power change thresholds, and the second predetermined threshold may include a positive power change threshold. The packet processing logic may be used to identify packet termination if power drops while tracking a packet rather than relying on the power level tracking system.

A variable gain amplifier (VGA) may be included with sufficient dynamic range for any one of the combined gain states. The control logic controls gain of the VGA to fine-tune power level based on a predetermined target power level after a combined gain state has been determined. Furthermore, an analog to digital converter (ADC) may be provided and coupled in the receive signal path after the VGA, where the ADC has a predetermined digital range. The predetermined target power level may include a target power backoff relative to the predetermined digital range of the ADC.

In one configuration, the control logic includes a digital integration and dump power circuit. Each of the power detectors performs analog integration and dump power determination. The control logic includes a state machine that synchronizes analog and digital integration and dump while tracking energy in a locked state and temporarily suspends digital integration and dump during an unlocked state when the power level of the energy exceeds the predetermined threshold.

In a specific embodiment, the control logic includes a DC canceller coupled to the ADC, a power estimator coupled to the DC canceller, a digital integrate and dump block coupled to the power estimator, a sample averaging block coupled to the digital integrate and dump block, a first scale converter coupled to the sample averaging block, a differential comparator coupled to the scale converter and receiving a target power backoff signal and having an output for asserting an error signal indicative thereof, an accumulator coupled to the output of the differential comparator, a second scale converter coupled to an output of the accumulator, a digital to analog converter (DAC) having an input coupled to the second scale converter and an output coupled to a control input of the VGA, and a state machine. The state machine is coupled to the accumulator, the differential comparator, the power detectors and the multi-state gain elements for determining the combined gain state of the multi-state gain elements.

A radio frequency (RF) communication device that communicates packet-based information in a wireless medium according to an embodiment of the present invention includes an antenna, RF circuitry, IF circuitry and a baseband processor. The RF circuitry includes a first amplifier and RF mixer circuitry. The first amplifier has an input that receives RF signals from the antenna, an output, and a gain control input for switching the first amplifier between a high gain state and a low gain state. The RF mixer circuitry converts the RF signals to intermediate frequency (IF) signals. The IF circuitry includes a first power detector that detects a power level of the IF signals, a second amplifier, a second power detector, IF mixer circuitry, a third amplifier, a third power detector, and a vernier amplifier. The second amplifier has an input that receives the IF signals, an output, and a gain control input for switching the second amplifier between a high gain state and a low gain state. The second power detector detects a power level at the output of the second amplifier. The IF mixer circuitry converts IF signals to baseband signals. The third amplifier has an input that receives the baseband signals, an output, and a gain control input for switching the third amplifier between a high gain state and a low gain state. The third power detector detects a power level at the output of the third amplifier. The vernier amplifier has an input coupled to the output of the third amplifier, an output and a gain control input for controlling gain. The RF communication device also includes a baseband processor, coupled to the IF circuitry, that further includes an ADC, a digital power detector and a state machine.

The state machine controls detection and determination of gain level in a similar manner as previously described. For example, the state machine operates in a locked state while a power level measured by the digital power detector is within a predetermined power range, switches to an unlocked state when the power level exits the predetermined power range, and changes a combined gain state of the first, second and third amplifiers in the unlocked state if a different combined gain state is indicated by the first, second and third power detectors. Additional functions and features may be included in the baseband processor in a similar manner as described above for the rapid acquisition gain control system.

A method of rapid acquisition gain control is disclosed for a wireless communication device having a plurality of multi-state gain elements sequentially coupled in a receive signal path of the communication device between a radio frequency (RF) input and baseband. The communication device includes a plurality of power detectors, where each power detector detects power associated with a respective one of the plurality of gain elements. The method includes tracking a power level of baseband signals while in a locked state, detecting a power level change of the baseband signals that exceeds a predetermined threshold and switching to an unlocked state, determining if any of the power detectors indicate an overload condition, and switching a combined gain state of the multi-state gain elements during the unlocked state to a different combined gain state indicated by the power detectors if an overload condition exists.

In one configuration, the multi-state gain elements include first, second and third dual-state gain elements and the power detectors include a corresponding first, second and third power detectors. In this case, the switching a combined gain state may include maintaining an existing combined gain state if the power level increases and if none of the power detectors indicates overload, switching each of the first, second and third gain elements to a high gain state if the power level decreases, switching each of the first, second and third gain elements to a low gain state if the power level increases and if the first power detector indicates overload, switching the second and third gain elements to low gain states and the first gain element to a high gain state if the power level increases and if the first power detector does not indicate overload while the second power detector indicates overload, and switching the first and second gain elements to a high gain state and switching the third gain element to a low gain state if the power level increases and if the first and second power detectors do not indicate overload while the third power detector indicates overload. The switching each of the first, second and third gain elements to a high gain state if the power level decreases may be limited to include switching only if tracking noise rather than tracking a packet.

The method may further include delaying after an initial switching of the combined gain state, and switching the combined gain state of the plurality of multi-state gain elements again during the unlocked state to another combined gain state if another overload condition occurs after the initial combined gain state switching.

A vernier amplifier may be provided in which it is coupled in the receive signal path after the multi-state gain elements. In this case, the method may include converting analog baseband signals to digital baseband signals having a predetermined digital range, and adjusting gain of the vernier amplifier relative to a target backoff based on the predetermined digital range. The method may further include fine-tuning the gain of the vernier amplifier during the unlocked state after a final switching of the combined gain state.

The communication device may include packet logic that monitors baseband signals to detect transmission of a packet and that asserts a packet indication signal indicative thereof. In this case, the detecting a power level change may further include detecting a power level change of the baseband signals that exceeds a first predetermined threshold and switching to the unlocked state when the packet indication signal indicates noise signals, and detecting a power level change of the baseband signals that exceeds a second, larger predetermined threshold and switching to the unlocked state when the packet indication signal indicates a packet. The detecting a power level change of the baseband signals that exceeds the second predetermined threshold and switching to the unlocked state may include switching only upon power increase. Also, the method may further include resetting operation while tracking a packet if the packet logic indicates packet termination.

The tracking and detecting may include digital integration and dump, indicating an overload condition using analog integration and dump, synchronizing analog and digital integration and dump while tracking, and suspending digital integration and dump upon entering the unlocked state. The method may further include re-entering the locked state after new gain determination during the unlocked state and re-synchronizing analog and digital integration and dump after re-entering the locked state.

### BRIEF DESCRIPTION OF THE DRAWINGS

A better understanding of the present invention can be obtained when the following detailed description of exemplary embodiments is considered in conjunction with the following drawings, in which:

FIG. 1 is a schematic block diagram of a wireless radio frequency (RF) transceiver implemented according to an embodiment of the present invention.

FIG. 2 is a more detailed block diagram of the AGC control logic of FIG. 1 as interfaced to the amplifiers, the power detectors, and the vernier amplifier via the ADC and the DAC.

FIG. 3 is a timing diagram illustrating a packet transmitted via the wireless medium and general operation of the transceiver of FIG. 1 performing rapid acquisition and packet tracking.

FIG. 4 is a figurative chart diagram illustrating relationship between exemplary combined gain states of the amplifiers and corresponding aperture of the ADC of FIG. 1.

FIG. 5 is a state diagram illustrating exemplary operation of the state machine of FIG. 2.

### DETAILED DESCRIPTION OF EMBODIMENT(S) OF THE INVENTION

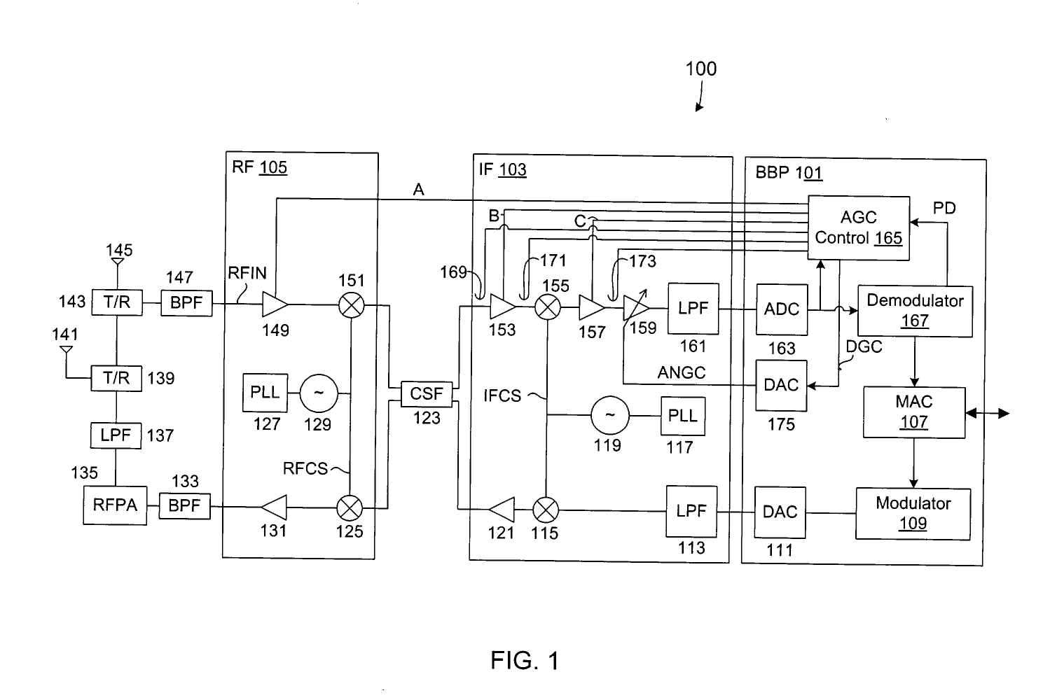

FIG. 1 is a schematic block diagram of a wireless radio frequency (RF) transceiver 100 implemented according to an embodiment of the present invention. The transceiver 100 may be used to communicate with one or more similar wireless devices across a wireless medium, such as within a wireless local area network (WLAN) or the like. Although the present invention is illustrated for use in a WLAN device in exemplary embodiments, it is understood that the present invention applies to any radio or wireless communication device and is not limited to WLAN applications.

The transceiver 100 may be used by any type of communication device to incorporate wireless communication capabilities, such as a wireless access point (AP), any type of computer or computer system (e.g., personal computers, laptop computers, desktop computers, etc.,), printing devices including any type of printer technology, personal digital assistants (PDAs) or the like, scanners, fax machines, etc. The transceiver 100 may be configured as a plug-in peripheral or expansion card that plugs into an appropriate slot or interface of a computer system, such as a Personal Computer Memory Card International Association (PCMCIA) card or PC Card or may be implemented according to any type of expansion or peripheral standard, such as according to the peripheral component interconnect (PCI), the Industry Standard Architecture (ISA), the Extended-ISA (EISA) standard, etc. Mini PCI cards with antennas embedded in displays are also contemplated. Self-contained or standalone packaging with appropriate communication interface(s) is also contemplated, which is particularly advantageous for APs. The transceiver 100 may be implemented as a separate unit with serial or parallel connections, such as a Universal Serial Bus (USB) connection or an Ethernet interface (twisted-pair, coaxial cable, etc.), or any other suitable interface to the device. Other types of wireless devices are contemplated, such as any type of wireless telephony device including cellular phones.

The transceiver 100 may be implemented according to the IEEE 802.11a standard operating at approximately 5 Gigahertz (GHz) for use within a WLAN. The IEEE 802.11a standard defines data rates of 6, 9, 12, 18, 24, 36, 48 and 54 megabits per second (Mbps) in the 5 GHz band employing orthogonal frequency division multiplexing (OFDM). OFDM is a multi-carrier modulation technique in which data is carried on a plurality of “tones” or “sub-carriers” associated with a multi-carrier signal. In the OFDM embodiment, communication is implemented using packets of information including one or more synchronization fields followed by a data payload implemented using a plurality of OFDM symbols. The synchronization fields typically include a series of short syncs (SS) followed by a series of long syncs (LS) each implemented using a predefined set of modulated tones. In an OFDM configuration, 52 sub-carrier signals are incorporated within each OFDM symbol, including 48 data tones and 4 pilot tones as known to those skilled in the art. Data is incorporated on each data tone using a selected modulation scheme, such as Binary Phase Shift Keying (BPSK), Quadrature PSK (QPSK), 16 Quadrature Amplitude Modulation (QAM), and 64 QAM. It is appreciated, however, that the teachings of the present invention may be applied in the same or similar manner to other types of wireless communication in which data is transmitted using a plurality of sub-carriers distributed in frequency and communicated via a selected RF band.

In one exemplary embodiment, it is desired that the transceiver 100 be compliant with IEEE 802.11a. It is desired that the architecture be configured to converge on an incoming signal in a relatively short amount of time after the start of 7 short syncs at the beginning of an incoming packet, such as in less than 5,600 nanoseconds (ns). It is desired that the transceiver 100 have a dynamic range of −85 dBm (decibels referenced to milliwatts) to −20 dBm and that tracking of the signals be maintained within 0.15 decibels (dB). It is further desired that the transceiver 100 reject adjacent channel signals as high as 16 dB greater than the desired signaland alternate adjacent channel signals as high as 32 dB greater than the desired signalat the radio antenna. As described more fully below, the transceiver 100 provides rapid acquisition of packet based transmissions without prior knowledge of any given packet's signal power at the receiver antenna. Rapid acquisition significantly reduces transmission time and increases data transmission throughput.

The transceiver 100 includes three primary components including a baseband (BB) processor 101, an intermediate frequency (IF) block 103 and an RF block 105. A separate chip or integrated circuit (IC) may incorporate the functions of a respective one of the components 101-105, although the present invention is not limited to any particular design configuration or implementation. Digital data sent from an underlying communications device is processed through a media access controller (MAC) 107 within the BB processor 101. The MAC 107 formats the data into frames and manages the timing of transmissions. When transmission is initiated, the MAC 107 passes the formatted data to a modulator 109 that encodes the packet data onto a modulated carrier. The modulator 109 outputs a digitized waveform to a transmit digital to analog converter (DAC) 111, which converts the digital signal to an analog waveform.

The transmit analog waveform is then conditioned by a transmit low pass filter (LPF) 113 within the IF block 103 and upconverted to an intermediate frequency (IF) by a transmit IF upconverter 115. An IF phase lock loop (PLL) 117 controls a voltage controlled oscillator (VCO) 119 or the like, which provides an IF carrier signal (IFCS) to one input of the IF mixer or upconverter 115, which receives the output of the LPF 113 at its other input. The upconverted signal at the output of the upconverter 115 is amplified by a transmit IF amplifier 121 and passed to a channel select filter (CSF) 123. The CSF 123 is a bidirectional device also used for receive functions described below.

In the transmit path, the CSF 123 rejects unwanted spurious signals from further transmit processing and provides a filtered IF signal to one input of an RF upconverter 125 within the RF block 105. An RF PLL 127 controls an RF VCO 129, which provides a radio frequency carrier signal (RFCS) to another input of the RF upconverter 125. The RF upconverter 125 operates in a similar manner as the IF upconverter 115 and translates the signal to a final transmit RF frequency. The RF upconverted signal at the output of the RF upconverter 125 is passed through an amplifier 131 and filtered by a transmit band pass filter (BPF) 133. The filtered RF signal is then passed to an RF power amplifier (RFPA) 135 for final amplification. The RFPA 135 output passes through a roofing LPF 137 to a transmit/receive (T/R) switch 139. The T/R switch 139 either routes the signal to a primary transmit antenna 141 or to a secondary transmit antenna 145 through another T/R switch 143.

When the transceiver 100 is operating in receive mode to receive incoming signals, the T/R switch 143 is set to receive signals from either the antenna 145, which operates as the secondary receive antenna, or from the primary receive antenna 141 through the T/R switch 139. A BPF 147 filters signals outside of the receive band. The filtered received RF input signal (RFIN) is then provided to the input of a low noise amplifier (LNA) 149 within the RF block 105. The LNA 149 is the first of three dual-state gain elements or amplifiers distributed in frequency in the receive signal path of the transceiver 100. The state of each of the three distributed amplifiers is described more fully below, where each has a high gain state (H) for and a low gain state (L). The output of the LNA 149 is provided to one input of an RF down-converter 151, which receives the RFCS signal at its other input. The signal is down-converted by the RF down-converter 151 to IF and passed to a receive side input of the CSF 123 to reject adjacent signals outside of the desired signal passband.

The receive-side output of the CSF 123 is provided to the input of a second dual state amplifier 153 within the IF block 103, which amplifies the IF signal by a relatively high gain amount in a high gain state (H) or by a relatively low gain amount in a low gain state (L). The amplified signal is provided to one input of an IF downconverter 155, which receives the IFCS signal at its other input and operates to downconvert the signal to near baseband. The downconverted baseband signal is then amplified by a third dual-state amplifier 157 also having both a high gain state and a low gain state. The amplified baseband signal is provided to the input of a variable gain amplified (VGA) or vernier amplifier 159, is passed through a receive LPF 161, and provided to a receive ADC 163 within the BB processor 101. The ADC 163 converts the received baseband analog signal into digital format and provides the digital signal to Automatic Gain Control (AGC) control logic 165 and to a demodulator 167. The demodulator 167 decodes the digital data by removing a modulated carrier and provides packet data to the MAC 107. The MAC 107 removes the framing and forwards received digital data to the associated communications device. The demodulator 167 and the MAC 107 collectively comprise packet processing logic for identifying packets and determining packet status.

The AGC control logic 165 has three additional inputs coupled to three power detectors 169, 171 and 173 located within the IF block 103. The first power detector 169 detects the power of the IF signal at the input of the amplifier 153, and effectively determines whether the gain setting of the LNA 149 needs to be changed. The second power detector 171 detects the power of the intermediate frequency signal at the output of the second dual state amplifier 153 and is used to determine whether to change the gain setting of the amplifier 153. The third power detector 173 detects the power of the baseband signal at the output of the third dual state amplifier 157 and is used to determine whether to change the gain setting of the amplifier 157. In one embodiment, the detectors 169, 171 and 173 have programmable power level detection points. The AGC control logic 165 has three corresponding output signals A, B and C that are used to control the gain states of the LNA 149, the amplifier 153 and the amplifier 157, respectively. The collective status of the A, B and C signals defines a combined gain state of the amplifiers 149, 153 and 157.

The AGC control logic 165 also controls the vernier amplifier 159 by asserting a digital gain control (DGC) signal to the input of a DAC 175, which asserts a corresponding analog gain control (ANGC) signal to a gain control input of the vernier amplifier 159. Although the vernier amplifier 159 is controlled by a DAC in the embodiment shown, it is understood that alternative embodiments are contemplated, such as providing control through a set of digital pins or via a sufficiently fast serial interface. As described further below, the AGC control logic 165 monitors the power detectors 169, 171 and 173 and the output of the ADC 163 and determines power estimation, senses signal conditions, and controls the combined gain state of the amplifiers 149, 153 and 157 and the variable gain of the vernier amplifier 159 to enable rapid acquisition of the incoming signal. A primary function of the AGC control logic 165 is to track the power level of energy being processed in the receive signal path of the transceiver 100 and set the appropriate gain level so that the demodulator 167 and the MAC 107 can received and decipher the received information. In one embodiment, the AGC control logic 165 tracks both the noise level and packets being transmitted in the wireless medium. The demodulator 167 asserts a packet detect (PD) signal or the like to the AGC control logic 165, where the status of the PD signal may effect specific tracking operation of the AGC control logic 165, such as conditions for lock or unlock while tracking as further described below.

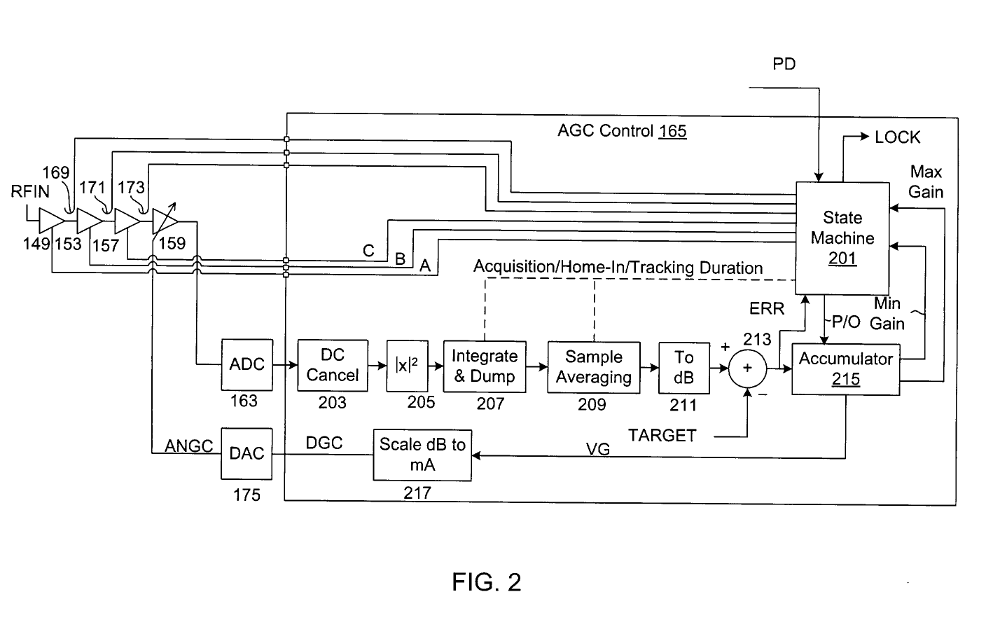

FIG. 2 is a more detailed block diagram of the AGC control logic 165 as interfaced to the amplifiers 149, 153 and 157, the power detectors 169, 171 and 173, and the vernier amplifier 159 via the ADC 163 and the DAC 175. The AGC control logic 165 includes a state machine 201 that performs rapid acquisition processing and noise/packet tracking control according to an embodiment of the present invention. The RFIN signal is shown provided at the input of the LNA 149, and intermediate devices between the amplifiers 149, 153, 157 and 159 are suppressed for purposes of simplicity and clarity. Control is centralized in the state machine 201, which is responsible for interpreting the power detector states, switching the dual state amplifiers 149, 153 and 157 to any one of multiple combined gain states, and managing the other blocks in the AGC control logic 165 that are responsible for refined measurement and tracking.

Energy of the wireless medium is processed in the receive signal path of the transceiver 100, and corresponding baseband signals are provided through a power measurement path including DC cancellation 203, instantaneous power calculation 205, digital integration and dump (I&D) 207, sample averaging 209, conversion to decibels (dB) 211, and comparison with a TARGET signal via a summing junction or differential comparator 213. The I&D 207 and the sample averaging 209 provide acquisition, HomeIn and tracking duration functions for the state machine 201.

During acquisition of an incoming signal, once the dual state amplifiers 149, 153 and 157 have settled and the vernier amplifier 159 is set to a measurement gain, the TARGET signal is subtracted from the output of the converter 211 by the differential combiner 213, and the difference is a measured deviation error signal (ERR) that is provided to the state machine 201 and an accumulator 215. It is noted that the ADC 163 has sufficient dynamic range for demodulation with acceptable packet error rate (PER). In the embodiment shown, the TARGET signal represents a backoff target power of the signal input to the ADC 163 relative to the full scale input power to provide sufficient headroom for maximum acceptable clipping plus any additional uncertainties. The state machine 201 receives the ERR signal and adds or subtracts the necessary gain to the vernier amplifier 159 by pre-setting the accumulator 215. The accumulator 215 asserts Maximum (Max) and Minimum (Min) Gain signals to the state machine 201. The state machine 201 asserts a preset or override (P/O) signal to the accumulator 215 when conditions dictate these operations. The accumulator 215 asserts a variable gain (VG) output signal that is scaled to appropriate voltage values by a scale block 217 and the resulting DGC control signal is provided to the gain control DAC 175. The ANGC analog output of the DAC 175 is provided to the control input of the vernier amplifier 159 for fine tuning control of the gain of the receive signal.

During tracking, after successful rapid acquisition, power measurements are continually made. In the embodiment shown, increased integration times are used to reduce measurement variance. The differential combiner 213 produces the ERR signal, which is added to or subtracted the value in the accumulator 215 forming a closed loop path to the vernier amplifier 159 through the scale block 217 and DAC 175. When tracking, the continual power measurements indicate whether the receiver output signal is at, or very near, the target level within some predefined limits. Under this condition the state machine 201 declares lock on the signal and asserts a corresponding LOCK signal indicating the locked state. If the accumulator 215 reaches a state indicating that the vernier amplifier 159 has reached maximum or minimum gain (and corresponding assertion of the MAX or MIN GAIN signals, respectively), and lock has not occurred, the state machine 201 can take appropriate action. Such action may include, for example, reset and/or notification of higher-level data processing.

As noted previously, the AGC control logic 165 tracks both the noise floor level and packets transmitted in the wireless channel. Once in the locked state, the conditions for entering the unlocked state differ for noise and packets as indicated by the PD signal provided to the state machine 201. In one embodiment, for example, the state machine 201 unlocks while tracking noise in the event the power level changes by approximately 4-5 dB and unlocks while tracking packets in the event the power level changes by approximately 8-10 dB. It is appreciated that the packet power change window is greater than the noise power change window so that it is more difficult to unlock while tracking a packet being received. The demodulator 167 makes a packet determination based on correlation of the preamble waveform and correct parity bit on the received header. In one embodiment, the PD signal is used as a release signal in which the demodulator 167 assumes a packet upon increase in power level and asserts the PD signal early until it is determined that a packet is not being transmitted. Alternatively, the PD signal is asserted only after packet verification. The PD signal is negated if no packet or after the packet is terminated. In any event, the state machine 201 employs the appropriate power window while tracking to determine the unlock condition.

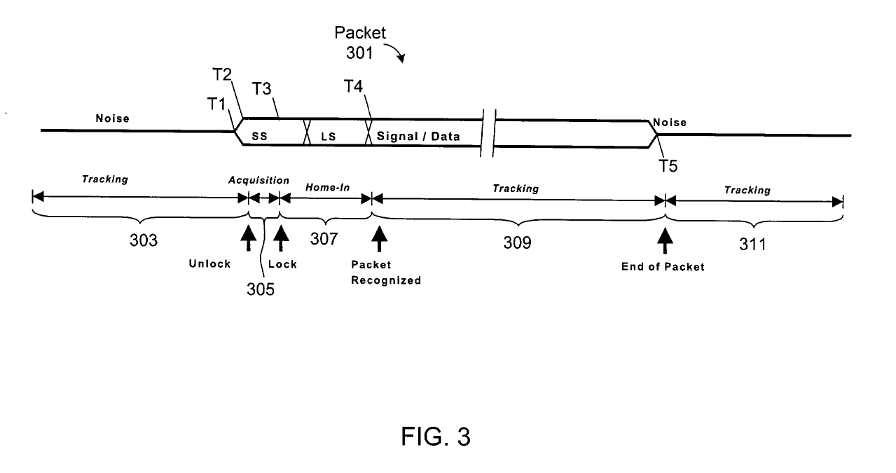

FIG. 3 is a timing diagram illustrating a packet 301 transmitted via the wireless medium and general operation of the transceiver 100 performing rapid acquisition and packet tracking. During an initial period 303, the state machine 201 is in the locked state while tracking noise in the wireless medium. The state machine 201 checks the status of the power level on a periodic basis, such as every 800 ns. In one embodiment, the power detectors 169-173 perform analog integration and the AGC control logic 165 performs digital integration, where the analog and digital integrations are synchronized by the AGC control logic 165 while tracking. For example, the state of the power detectors 169-173 and the I&D 207 and the sample averaging 209 are checked periodically, such as every 800 ns.

At a time T1, the packet 301 arrives at the applicable receive antenna 141 or 145. At subsequent time T2, the state machine 201 detects a power increase indicating the potential onset of a packet and enters an unlocked state to initiate a rapid acquisition time period 305. The state machine 201 unlocks in the event of a significant power change in the wireless channel, such as approximately 4-5 dB power change in the current noise floor. The state machine 201 detects the packet 301, performs amplifier switching and settling, digital measurement integration, and final amplifier switching and settling in an attempt to lock in on the power level of the packet 301. The acquisition time period 305 terminates at a subsequent time T3 upon assertion of the LOCK signal by the state machine 201. It is desired that the locked state occur during the Short Sync period (SS) of the packet 301, although it is possible that lock be delayed and not occur until the subsequent Long Sync period (LS).

The acquisition time period 305 is followed by a Home-In period 307, during which time the AGC control logic 165 conducts a more refined power estimation of the packet 301. A hold or delay period is inserted to allow for final settling. At the end of the Home-In period 307 at a time T4, the state machine 201 performs a one-step jam operation to fine-tune the vernier amplifier 159 to center the power of the incoming signal in the ADC 163. During the Home-In period 307 or a short time thereafter, the transceiver 100 recognizes the packet 301 and a packet tracking period 309 is conducted while the transceiver 100 retrieves the signal or data portion of the packet 301. An expanded packet power tracking window (e.g., 8-10 dB) is used while tracking the packet 301. Otherwise, if it is determined that a packet is not present, the original noise power tracking window is sustained. The packet 301 ends at a time T5 in which the AGC control logic 165 returns to tracking noise during a subsequent period 311 before onset of a new packet.

The present invention contemplates a plurality of multi-state amplifiers distributed in the receive path of a wireless receiver for establishing a gain range. Although the embodiment illustrated includes 3 dual-state amplifiers, it is understood that any number of (2 or more) multi-state amplifiers are contemplated. Also, although the embodiment illustrated shows dual-state amplifiers with either high or low gain, the present invention contemplates amplifiers with any number of suitable states (2 or more) depending upon the desired granularity of corresponding gain ranges. The use of dual-state amplifiers simplifies the logic of the state machine 201. Another simplification is the location of the power detectors 169, 171 and 173 employed to detect and report the output of the amplifiers 149, 153 and 157. In particular, the first power detector 169, used to determine the output of the LNA 149, is positioned within the IF block 103 rather than the RF block 105. In this manner, all three of the power detectors are conveniently located within one functional block.

Furthermore, although 3 dual-state amplifiers potentially include up to 8 different binary states according to simple binary logic principles, only 4 states are employed since certain states may be considered redundant or otherwise equivalent. In particular, if the state of the amplifiers 149, 153 and 157 is defined as XXX, where each “X” is defined as H for high gain or L for low gain, then the legal states used are LLL, HLL, HHL and HHH, where the potential states LHL and LLH are considered unnecessary. The initial state of the amplifiers 149, 153 and 157 is set by the state machine 201 prior to onset of a transmitted signal to the gain level of the noise in the channel prior to onset of a packet. Generally, the noise level should be low enough so that the highest combined gain state of HHH is used to detect potentially very weak RF signals. If the wireless medium exhibits a substantial noise floor, however, then the initial state may be a lower combined gain state even (e.g., HHL or HLL) though a relatively weak signal may not be detected. A signal in the wireless medium must raise the power level beyond the applicable power change window to be detected.

The present invention also contemplates the use and control of a VGA, such as the vernier amplifier 159, to fine tune the power level within the selected gain range to center the signal for baseband processing. The vernier amplifier 159 is optional and may be employed in a worst-case, set and forget AGC configuration. The back-off target power level, as represented by the TARGET signal, should be greater to provide a larger window of error in the event the vernier amplifier 159 is not used. The vernier 159 enables more precise gain measurement to reduce estimation uncertainty and to mitigate wobble while tracking energy in the wireless medium.

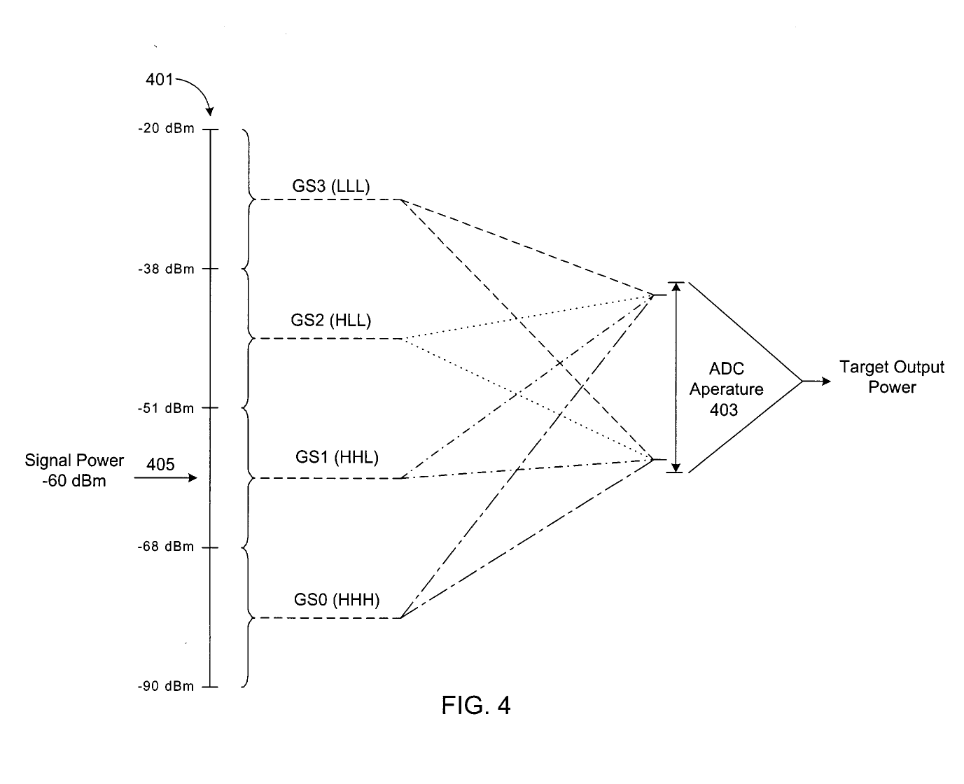

FIG. 4 is a figurative chart diagram illustrating relationship between exemplary combined gain states of the amplifiers 149, 153 and 157 and corresponding aperture 403 of the ADC 163. An exemplary dBm scale 401 is shown in which the expected signal power of a signal transmitted via the wireless medium is within −20 and −90 dBm. The scale 401 is divided into four segments or gain ranges GR0, GR1, GR2 and GR3 corresponding to the combined gain states HHH, HHL, HLL and LLL, respectively, of the amplifiers 149, 153 and 157. For example, the first gain range GRO is used for signals in the range −68 to −90 dBm, the second gain range GRI is used for signals in the range −51 to −68 dBm, the third gain range GR2 is used for signals in the range −38 to −51 dBm, and the fourth gain range GR3 is used for signals in the range −20 to −38 dBm. The input signal is amplified by the selected combined gain state of the amplifiers 149, 153 and 157 and then applied to the input of the vernier amplifier 159.

The aperture of the ADC 163, shown at 403, is configured to overlap the potential input signal range after amplification by the amplifiers 149, 153 and 157 in any of the selected gain ranges GRO-3 by appropriate setting of the vernier amplifier 159. A power measurement is made by observing samples out of the ADC 163. The state machine 201 is then able to control the vernier amplifier 159 to set the power of the input signal to the desired target power level by readjusting the vernier amplifier 159 gain. In this manner, the ADC 163 has sufficient dynamic range to measure the signal power anywhere in the selected dynamic gain range segment. An exemplary input signal with a signal power of −60 dBm is shown at 405, which causes the state machine 201 to select and lock at the combined gain range GRI to amplify the input signal by the appropriate amount to be within the ADC aperture 403. The vernier amplifier 159 is then used to control the input signal power to the target power level.

It is noted that in the HHH gain state, if a previous amplifier is saturated by an incoming signal, then the following amplifiers will be saturated as well. Thus, if the front-most amplifier LNA 149 is saturated, then the subsequent amplifiers 153 and 157 will also be saturated, and if the second amplifier 153 is saturated (while the first is not), then the last amplifier 157 is also saturated. The power detectors 169, 171 and 173 determine overload (saturation) of the amplifiers 149, 153 and 157, respectively. In this manner, the state machine 201 is able to make a quick preliminary switching decision based on the power detectors.

The state machine 201 is configured to take periodic assessment of the state of the power detectors 169-173 and the signal level of the wireless medium via the digital processing of the AGC control logic 165. The power detectors 169-173 each perform analog integration and dump (I&D), such as sampling amplifier output using a capacitor and latching the voltage. The I&D 207 performs digital I&D which is an accumulation of digital samples. The analog and digital I&D are synchronized during locked and tracking periods such as while locked and tracking noise or while locked and tracking a packet. In one embodiment, analog and digital samples are processed every 800 ns by the state machine 201, so that the state machine 201 determines the analog and digital status on a synchronized and periodic basis. Upon detection of a significant power change in the wireless channel, however, such as by onset of a packet or a substantial noise level change, an unlock condition occurs in which the digital integration process is temporarily held and possibly aborted and restarted while amplifier switching occurs to recapture the appropriate gain state. The analog and digital integration processes are not synchronized with respect to each other during amplifier switching, power measurement, settling, and home-in integration to re-stabilize the acquisition process. Once stabilized, the analog and digital integration processes are re-synchronized.

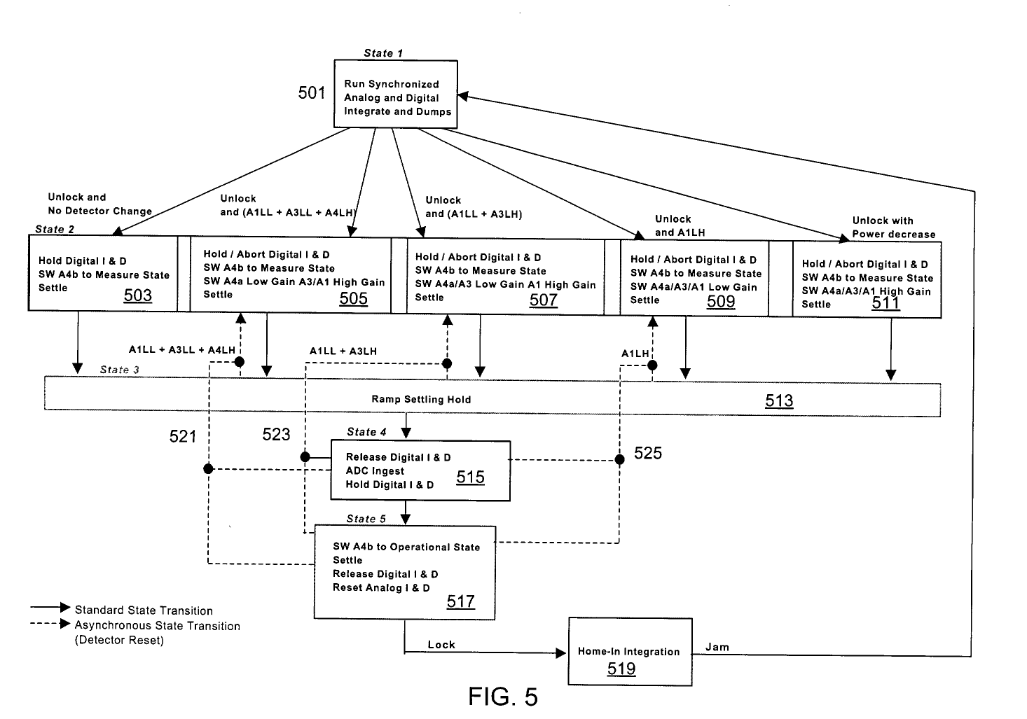

FIG. 5 is a state diagram illustrating exemplary operation of the state machine 201. Operation begins at a first state (State 1) 501 while the AGC control logic 165 is tracking the noise in the wireless channel prior to onset of a packet, such during the initial noise tracking period 303, or while tracking a packet, such as the packet tracking period 309. The state machine 201 is “locked” on the signal and monitoring its power level. The combined gain state of the amplifiers 149, 153 and 157 in state 501 depends on the power of the signal or noise being tracked. The noise floor is usually relatively low so that a combined gain state of HHH is typical while tracking noise. Of course, the amplifiers 149, 153 and 157 may be in one of the lower combined gain states for larger noise levels. If tracking a packet, the gain state depends on the power level of the packet.

The state machine 201 unlocks in the event of a predetermined power level variation relative to the power level of the signal or noise being tracked and enters a second state (State 2). The predetermined power level variation is based on a selected power window, which is different for noise and packets as previously described. The second state includes several sub-states 503, 505, 507, 509 and 511 depending upon the status of the power detectors 169-173 when unlock occurs. If none of the power detectors 169-173 have “tripped” (i.e., detected an overload condition) upon unlock, then operation proceeds to substate 503. Since none of the power detectors 169-173 detected an overload condition, the state machine 201 does not change the combined gain state of the amplifiers 149, 153 and 157 in substate 503. Digital I&D is held while the state machine 201 switches the vernier amplifier 159 to set up for measurement of the power level the potential incoming signal. (Power measurement and final setting of the vernier amplifier 159 to the gain required to place the signal at the desired target level occurs in subsequent states described below.)

If the last power detector 173 trips while the power detectors 169 and 171 do not, then operation proceeds to substate 505 in which the state machine 201 switches the gain state of the amplifier 157 to its low state and switches the gain state of the amplifiers 149 and 153 to the high gain state to achieve the combined gain state HHL applicable to the gain range GR1. While the amplifiers are switching, digital I&D is held and the state machine 201 controls the vernier amplifier 159 to set up for measurement of the power level of the potential incoming signal. Similarly, if only the power detectors 171 and 173 trip, then operation proceeds instead to substate 507 in which the state machine 201 switches the gain state of the amplifiers 153 and 157 to the low gain state and the amplifier 149 to the high gain state to achieve the new combined gain state HLL corresponding to the gain range GR2. While the amplifiers are switching, digital I&D is held and the state machine 201 controls the vernier amplifier 159 to set up for measurement of the power level of the potential incoming signal. If all of the power detectors 169-173 trip, then operation proceeds instead to substate 509 in which the state machine 201 switches the gain state of the amplifiers 149, 153 and 157 to low gain to enter the new combined gain state LLL corresponding to gain range GR3. Again, digital I&D is held and the state machine 201 controls the vernier amplifier 159 to begin set up for measurement of the power level potential incoming signal. (Power measurement and final setting of the vernier amplifier 159 to the gain required to place the signal at the desired target level occurs in subsequent states described below.)

The last substate 511 of State 2 is provided in the event that the power level decreases and when any one or more of the amplifiers 149, 153 and 157 are in the low gain state. This condition generally occurs when tracking noise in the wireless channel and an interference that had temporarily increased the noise power level disappears causing a significant noise drop. The power detectors 169-173 are considered accurate to detect an overload condition when a corresponding one of the amplifiers 149, 153 and 157, respectively, is in the high gain state. If and when any of the amplifiers 149, 153 and 157 are switched to the low gain state, the corresponding power detectors 169-173 are no longer considered reliable to indicate the input signal condition. In the substate 511, the amplifiers 149, 153 and 157 are all switched back to the high gain state to achieve the combined gain state HHH corresponding to gain range GRO and the vernier amplifier 159 is used for measuring the input signal. A subsequent overload condition may cause additional switching to any of the lower combined gain states if necessary.

The conditions for entering the substate 511 may also be met during packet tracking in some configurations. The packet power drops off at termination, which may either be normal or abnormal termination. It is generally undesirable, however, to enter the unlocked state after a packet is declared since the state machine 201 may not have all of the information necessary to make the end of packet decision. In one embodiment, the MAC 107 is employed to determine whether a packet is terminated since the MAC 107 is able to make this decision more accurately. The packet power window may be expanded on the low side, such as greater than 8-10 dB. Alternatively, the packet power window is not a window but instead only has a positive power increase threshold such that operation remains in state 501 and does not enter substate 511 during packet tracking regardless of the level of power decrease. In this case, the MAC 107 asserts a reset signal or the like (not shown) upon packet termination, which causes the AGC control logic 165 to switch from packet to noise tracking mode.

From any of the substates 503-511, operation proceeds to a ramp settling hold state (State 3) 513. Transmitted signals typically ramp up relatively quickly so that the first amplifier switching (if any) that occurs in any of the substates 503-509 should be accurate. Some specifications, such as the 802.11a specification, however, allows for slower ramp up of the transmitted signal so that the initially determined combined gain state may be inaccurate at initial unlock and additional amplifier switching may be necessary. The state 513 is a delay state inserted to allow detection of a slowly rising signal and to allow any remaining switching that may be necessary to arrive at the correct combined gain state.

Operation then proceeds from state 513 to power measurement state 515 (State 4), in which the AGC control logic 165 measures input signal power via the ADC 163. Digital I&D is released after being held in any of the substates of State 2 to make the power measurement and then held again upon the end of the measurement integration as described in the subsequent state processing below. Operation then proceeds to switch and settle state 517 (State 5) in which the state machine 201 switches the vernier amplifier 159 into the operational state. Digital I&D is released and analog I&D is reset in order to re-synchronize with digital I&D. The state machine 201 asserts the LOCK signal and operation proceeds to Home-In integration step 519 in which the AGC control logic 165 conducts a more refined power estimation of the signal. At the end of the Home-In integration step 519, the state machine 201 performs the one-step jam operation to fine-tune the vernier amplifier 159 to center the power of the signal in the ADC 163, and operation returns to state 501.

Three asynchronous links 521, 523 and 525 back to the substates 505, 507 and 509, respectively, are provided from each of the states 513, 515 or 517. Thus, if the power detector 169 trips in any of the states 513-517, asynchronous link 525 takes operation back to substate 509, in which the amplifiers are switched accordingly and the process is restarted. Operation is similar to that previously described except that any digital I&D processing in subsequent states is aborted. Likewise, if the power detector 171 trips in any of the states 513-517, asynchronous link 523 takes operation back to state 513, in which the amplifiers are switched, the process is restarted and any digital I&D is aborted. Also, if the power detector 173 trips in any of the states 513-517, the asynchronous link 521 takes operation back to state 513, in which the amplifiers are switched, the process is restarted and any digital I&D is aborted.

A rapid acquisition and tracking system for a wireless communication device according to an embodiment of the present invention includes two or more multi-state gain elements sequentially coupled in the receive signal path of the communication device. In one embodiment, the gain elements are distributed between the RF input and the baseband output including at least one gain element at RF, IF and baseband. It is contemplated, however, that the gain elements be centralized at any location in the receive path. When using one or more such multi-state devices, the radio system's total dynamic range is effectively increased by the allocation of different segments of the total range of input signals to particular gain state combinations of the gain elements.

The multi-state gain elements generally have at least one high gain state that amplifies the signal. The multi-state gain elements may also include a low gain state that buffers the signal with little or no attenuation. It is appreciated that the gain elements may have any number of gain states of any selected level of gain or attenuation. The gain elements may comprise dual-state amplifiers having either high or low gain.

A distributed detector scheme as described herein does not require that any single detector have a large dynamic range as was the case with typical power detection schemes employing a log amp. The distributed detector approach uses points in the actual receive signal chain to determine the power level. The receive signal chain is considered the most accurate signal processing path with the tightest tolerances. The use of the receive signal chain, which inherently eliminates inaccuracies due to estimation of its variation and tolerance, greatly enhances the ability to set the AGC level accurately in a shorter time frame. The distributed detector scheme, for example, enhances the ability to accurately set the AGC in the time frame required for the 802.11a standard employing shorter preambles. Because the detectors are distributed and the level of each is represented by a single bit of data, effectively providing a distributed parallel 3-bit flash ADC in the embodiment shown, there is no additional ADC requirement.

The present invention also contemplates a variable gain amplifier (VGA) or vernier gain element coupled in the receive signal path after the multi-state gain elements. The vernier element is controlled by power measurements and derived gain adjustment to fine tune power adjustment according to a predetermined target power level. The continuously variable, or vernier, amplifier of reduced range allows for precision gain adjustment within a selected gain range segment.

In one configuration, the combined gain state of the gain elements is coordinated by centralized control that is also responsible for control of the vernier amplifier. The initial combined gain state may be set for maximum gain to detect weak signals. The centralized control may, however, be configured to track the noise floor in the wireless medium so that a lower combined gain state may be appropriate at the onset of a packet. Sensors are provided at either the inputs or outputs of the gain elements to indicate whether signal conditions warrant a change in gain state. If change is indicated, controlling logic switches the combined gain state of the gain elements to most effectively receive the input signal. This process may be enabled or disabled depending upon other qualifying information, such as direct detection of sufficient energy by the digital control section at the end of the receiver's signal path.

Once the final combined gain state is determined and set, the vernier amplifier is set to some default gain that is optimal for a refined power measurement. An estimate is made of the receiver's output power for the given input signal within the chosen gain segment by integrating (averaging) the signal. The integration may be carried out with analog circuitry or, more conveniently, with digital circuitry following an analog to digital converter (ADC). Once the measurement is made, the difference between the measured signal power and the desired target signal power is calculated. This power difference is then converted to a gain difference. The gain difference is combined with the current gain of the vernier amplifier to produce a new gain for the vernier amplifier that results in the receiver output power equaling the target signal power. The vernier amplifier is adjusted accordingly and the control logic declares lock.

Once lock is declared and validated, the AGC control may continue to make small adjustments to the vernier gain in order to track changes in the input signal. Large and rapid changes in the input signal may, however, unlock the gain control and require repeating the acquisition process.

Although a system and method according to the present invention has been described in connection with the preferred embodiment, it is not intended to be limited to the specific form set forth herein, but on the contrary, it is intended to cover such alternatives, modifications, and equivalents, as can be reasonably included within the spirit and scope of the invention.

1. A rapid acquisition gain control system for a wireless communication device having a radio frequency (RF) input and a receive signal path including RF and baseband portions, comprising:
a plurality of multi-state gain elements sequentially coupled in the receive signal path, the collective gain elements having a plurality of combined gain states, each combined gain state corresponding to one of a plurality of gain range segments of a predetermined dynamic range;
a plurality of power detectors, each power detector coupled to detect output power level associated with a corresponding one of the plurality of multi-state gain elements; and
control logic, coupled to the multi-state gain elements and the power detectors, that changes the combined gain state of the plurality of multi-state gain elements if a change of power level of energy processed in the receive signal path exceeds a predetermined threshold and a different combined gain state is indicated by the plurality of power detectors.

2. The rapid acquisition gain control system of claim 1, wherein the plurality of multi-state gain elements comprise dual-state gain elements.

3. The rapid acquisition gain control system of claim 1, wherein the plurality of multi-state gain elements are distributed in frequency between RF and baseband.

4. The rapid acquisition gain control system of claim 3, wherein the receive signal path includes an intermediate frequency (IF) portion, and wherein the plurality of multi-state gain elements comprise a first dual-state gain element at RF, a second dual-state gain element at IF and a third dual-state gain element at baseband.

5. The rapid acquisition gain control system of claim 1, wherein:
the plurality of multi-state gain elements comprise first, second and third dual-state gain elements; and
wherein the plurality of combined gain states includes a first combined gain state in which the first, second and third gain elements are at high gain states, a second combined gain state in which the first and second gain elements are at high gain states and the third gain element is at a low gain state, a third combined gain state in which the first gain element is at a high gain state and the second and third gain elements are at low gain states, and a fourth combined gain state in which the first, second and third gain elements are at low gain states.

6. The rapid acquisition gain control system of claim 5, wherein:
the plurality of power detectors includes a first power detector that indicates power overload of the first gain element, a second power detector that indicates power overload of the second gain element, and a third power detector that indicates power overload of the third gain element;
wherein the control logic enters an unlock state upon detecting a change of power that exceeds the predetermined threshold;
wherein the control logic, upon entering the unlock state due to power level increase, maintains an existing combined gain state if none of the first, second and third power detectors indicate power overload, changes to the fourth combined gain state if the first power detector indicates power overload, changes to the third combined gain state if the first power detector does not indicate power overload and the second power detector indicates power overload, and changes to the second combined gain state if the first and second power detectors do not indicate power overload and the first power detector indicates power overload; and
wherein the control logic, upon entering the unlock state due to power level decrease, changes to the first combined gain state.

7. The rapid acquisition gain control system of claim 6, wherein the control logic includes a delay state after an initial combined gain state change and performs at least one subsequent combined gain state change in the event any of the power detectors indicate power overload prior to settling of input power level.

8. The rapid acquisition gain control system of claim 1, wherein the predetermined threshold comprises a first predetermined threshold used when the energy processed in the receive signal path comprises noise and a second, higher power level predetermined threshold when the energy processed in the receive signal path comprises a packet.

9. The rapid acquisition gain control system of claim 8, further comprising:
packet processing logic, coupled to the control logic, that monitors baseband signals to identify packets and that asserts a packet signal indicative thereof; and
the control logic tracking baseband power level and including a state machine that operates in a locked state while tracking the energy processed in the receive signal path and that switches to an unlocked state if the first predetermined threshold is exceeded while noise is indicated and that switches to the unlocked state if the second predetermined threshold is exceeded while a packet is indicated.

10. The rapid acquisition gain control system of claim 9, wherein the first predetermined threshold comprises a power change window including positive and negative power change thresholds, wherein the second predetermined threshold comprises a positive power change threshold and wherein the packet processing logic determines packet termination if power drops while tracking a packet.

11. The rapid acquisition gain control system of claim 1, further comprising:
a variable gain amplifier (VGA), coupled to the control logic and coupled in the receive signal path after the plurality of multi-state gain elements, that has sufficient dynamic range for any selected one of the plurality of combined gain states; and
wherein the control logic controls gain of the VGA to fine-tune power level based on a predetermined target power level after a combined gain state has been determined.

12. The rapid acquisition gain control system of claim 11, further comprising:
an analog to digital converter (ADC) coupled in the receive signal path after the VGA, the ADC having a predetermined digital range; and
the predetermined target power level comprising a target power backoff relative to the predetermined digital range of the ADC.

13. The rapid acquisition gain control system of claim 11, further comprising:
an analog to digital converter (ADC) coupled in the receive signal path after the VGA;
the control logic including a digital integration and dump power circuit;
each of the plurality of power detectors performing analog integration and dump power determination; and
the control logic including a state machine that synchronizes analog and digital integration and dump while tracking energy in a locked state and that temporarily suspends digital integration and dump during an unlocked state when the power level of the energy exceeds the predetermined threshold.

14. The rapid acquisition gain control system of claim 12, wherein the control logic further comprises:
a DC canceller coupled to the ADC;
a power estimator coupled to the DC canceller;
a digital integrate and dump block coupled to the power estimator;
a sample averaging block coupled to the digital integrate and dump block;
a first scale converter coupled to the sample averaging block;
a differential comparator, coupled to the scale converter and receiving a target power backoff signal, that has an output for asserting an error signal indicative thereof;
an accumulator coupled to the output of the differential comparator;
a second scale converter coupled to an output of the accumulator;
a digital to analog converter (DAC), having an input coupled to the second scale converter and an output coupled to a control input of the VGA; and
a state machine, coupled to the accumulator, the differential comparator, the plurality of power detectors, and the plurality of multi-state gain elements that determines the combined gain state of the plurality of multi-state gain elements.

15. A radio frequency (RF) communication device that communicates packet-based information in a wireless medium, comprising:
an antenna that receives RF signals;
RF circuitry, coupled to the antenna, comprising:
a first amplifier having an input that receives the RF signals, an output, and a gain control input for switching the first amplifier between a high gain state and a low gain state; and
RF mixer circuitry, coupled to the output of the first amplifier, that converts the RF signals to intermediate frequency (IF) signals;
IF circuitry, coupled to the RF circuitry, comprising:
a first power detector that detects a power level of the IF signals;
a second amplifier having an input that receives the IF signals, an output, and a gain control input for switching the second amplifier between a high gain state and a low gain state;
a second power detector that detects a power level at the output of the second amplifier;
IF mixer circuitry, coupled to the output of the second power detector, that converts IF signals to baseband signals;
a third amplifier having an input that receives the baseband signals, an output, and a gain control input for switching the third amplifier between a high gain state and a low gain state;
a third power detector that detects a power level at the output of the third amplifier; and
a vernier amplifier, having an input coupled to the output of the third amplifier, an output and a gain control input for controlling gain; and
a baseband processor, coupled to the IF circuitry, comprising:
an analog to digital converter (ADC), having an input coupled to the output of the vernier amplifier and an output that provides digital baseband signals;
a digital power detector, coupled to the output of the ADC; and
a state machine, coupled to the digital power detector, the gain control inputs of the first, second, third and vernier amplifiers, and the first second and third power detectors, that operates in a locked state while a power level measured by the digital power detector is within a predetermined power range, that switches to an unlocked state when the power level exits the predetermined power range, and that changes a combined gain state of the first, second and third amplifiers in the unlocked state if a different combined gain state is indicated by the first, second and third power detectors.

16. The RF communication device of claim 15, further comprising:
packet logic that monitors the baseband signals, that determines whether a packet is being transmitted in the wireless medium and that asserts a packet signal indicative thereof; and
wherein the predetermined power range comprises a first power window when the packet signal indicates noise and comprises a relatively large positive power change threshold when the packet signal indicates a packet.

17. The RF communication device of claim 16, wherein the packet logic includes a media access controller that resets operation upon detecting packet termination.

18. The RF communication device of claim 15, wherein the baseband processor further comprises:
power comparison logic, coupled to the digital power detector, that averages power level during the unlocked state, that compares the average power level with a predetermined target backoff, and that asserts an error signal indicative thereof; and
the state machine, coupled to the power comparison logic, controlling the vernier amplifier to fine-tune the power level after changing the collective gain state of the first, second and third amplifiers.

19. The RF communication device of claim 18, wherein:
the first, second and third power detectors perform analog integration and dump power determination;
the digital power detector and the power comparison logic collectively comprises:
a DC canceller coupled to the ADC;
a power estimator coupled to the DC canceller;
a digital integrate and dump block coupled to the power estimator;
a sample averaging block coupled to the digital integrate and dump block;
a first scale converter coupled to the sample averaging;
a differential comparator, coupled to the scale converter and receiving a target power signal, that has an output for asserting an error signal indicative thereof;
an accumulator coupled to the output of the differential comparator;
a second scale converter coupled to an output of the accumulator; and
a digital to analog converter (DAC), having an input coupled to the second scale converter and an output coupled to the gain control input of the vernier amplifier; and
wherein the state machine is coupled to the digital power detector and the power comparison logic and synchronously operates analog and digital integration and dump while tracking in the locked state and temporarily suspends digital integration and dump while in the unlocked state.

20. The RF communication device of claim 19, wherein the state machine controls the gain of the vernier amplifier to fine-tune power level in the unlocked state after a combined gain state is determined.

21. The RF communication device of claim 15, wherein the state machine controls the gain state of the first, second and third amplifiers to one of a first combined gain state in which the first, second and third amplifiers are each at a high gain state, a second combined gain state in which the first and second amplifiers are at high gain states and the third amplifier is at a low gain state, a third combined gain state in which the first amplifier is at a high gain state and the second and third amplifiers are at low gain states, and a fourth combined gain state in which the first, second and third amplifiers are each at a low gain state.

22. The RF communication device of claim 21, wherein the state machine, upon entering the unlock state due to a power level increase, maintains an existing combined gain state if none of the first, second and third power detectors indicate power overload, changes to the fourth combined gain state if the first power detector indicates power overload, changes to the third combined gain state if the first power detector does not indicate power overload and the second power detector indicates power overload, and changes to the second combined gain state if the first and second power detectors do not indicate power overload and the first power detector indicates power overload.

23. The RF communication device of claim 22, wherein the state machine changes to the first combined gain state upon entering the unlock state due to power level decrease.

24. The RF communication device of claim 23, wherein the state machine adds a delay after an initial combined gain state change while in the unlocked state to enable at least one additional combined gain state change in the event any of the power detectors indicate power overload after the initial combined gain state change.

25. A method of rapid acquisition gain control for a wireless communication device having a plurality of multi-state gain elements sequentially coupled in a receive signal path of the communication device between a radio frequency (RF) input and baseband, the communication device including a plurality of power detectors, each power detector detecting power associated with a respective one of the plurality of gain elements, the method comprising:
tracking a power level of baseband signals while in a locked state;
detecting a power level change of the baseband signals that exceeds a predetermined threshold and switching to an unlocked state;
determining if any of the power detectors indicate an overload condition; and
switching a combined gain state of the plurality of multi-state gain elements during the unlocked state to a different combined gain state indicated by the power detectors if an overload condition exists.

26. The method of claim 25, the plurality of multi-state gain elements comprising first, second and third dual-state gain elements, and the plurality of power detectors comprising first, second and third power detectors, wherein said switching a combined gain state comprises:
maintaining an existing combined gain state if the power level increases and if none of the power detectors indicates overload;
switching each of the first, second and third gain elements to a high gain state if the power level decreases;
switching each of the first, second and third gain elements to a low gain state if the power level increases and if the first power detector indicates overload;
switching the second and third gain elements to low gain states and the first gain element to a high gain state if the power level increases and if the first power detector does not indicate overload while the second power detector indicates overload; and
switching the first and second gain elements to a high gain state and switching the third gain element to a low gain state if the power level increases and if the first and second power detectors do not indicate overload while the third power detector indicates overload.

27. The method of claim 26, wherein said switching each of the first, second and third gain elements to a high gain state if the power level decreases comprises switching only if tracking noise rather than tracking a packet.

28. The method of claim 26, further comprising:
delaying after an initial combined gain state switching; and
switching the combined gain state of the plurality of multi-state gain elements again during the unlocked state to another combined gain state if another overload condition occurs after the initial combined gain state switching.

29. The method of claim 25, the communication device including a vernier amplifier coupled in the receive signal path after the plurality of multi-state gain elements, further comprising:
converting analog baseband signals to digital baseband signals having a predetermined digital range; and
adjusting gain of the vernier amplifier relative to a target backoff based on the predetermined digital range.

30. The method of claim 29, further comprising:
fine-tuning the gain of the vernier amplifier during the unlocked state after a final combined gain state switching.

31. The method of claim 25, the communication device including packet logic that monitors baseband signals to detect transmission of a packet and that asserts a packet indication signal indicative thereof, wherein said detecting a power level change further comprises:
detecting a power level change of the baseband signals that exceeds a first predetermined threshold and switching to the unlocked state when the packet indication signal indicates noise signals; and
detecting a power level change of the baseband signals that exceeds a second, larger predetermined threshold and switching to the unlocked state when the packet indication signal indicates a packet.

32. The method of claim 31, further comprising:
said detecting a power level change of the baseband signals that exceeds the second predetermined threshold and switching to the unlocked state comprises switching only upon power increase; and
resetting operation while tracking a packet if the packet logic indicates packet termination.

33. The method of claim 25, further comprising:
said tracking and detecting including digital integration and dump;
indicating an overload condition using analog integration and dump;
synchronizing analog and digital integration and dump while tracking; and
suspending digital integration and dump upon entering the unlocked state.

34. The method of claim 33, further comprising:
re-entering the locked state after new gain determination during the unlocked state; and
re-synchronizing analog and digital integration and dump after re-entering the locked state.
